(19) United States
(12) Patent Application Publication
(10) Pub. No.: US 2007/0173613 A1
(43) Pub. Date: Jul. 26, 2007

(54) Free-radical-initiated crosslinking of polymers

(75) Inventors: Bharat I. Chaudhary, Princeton, NJ (US); Yunwa W. Cheung, Lake Jackson, TX (US); Randall M. Cuntala, Columbia, NJ (US); Mohamed Esseghir, Monroe Township, NJ (US); John Klier, Midland, MI (US)

Correspondence Address: THE DOW CHEMICAL COMPANY, INTELLECTUAL PROPERTY SECTION,, P. O. BOX 1967, MIDLAND, MI, 48641-1967, US

(73) Assignee: Dow Global Technologied Inc., Midland, MI (US)

(21) Appl. No.: 10/583,299

(22) PCT Filed: Dec. 24, 2004
(86) PCT No.: PCT/US04/43346

§ 371 Date: Jun. 16, 2006

Related U.S. Application Data
(60) Provisional application No. 60/532,491, filed on Dec. 24, 2003.

(51) Int. Cl. C08F 8/30

(52) U.S. Cl. 525/374; 525/326.2; 525/329.1; 525/331.9; 525/333.7

(57) ABSTRACT

The present invention is a free-radical carbon-FRTS-carbon crosslinkable polymeric composition. The resulting carbon-FRTS-carbon crosslinked polymer is prepared from at least one polymer which upon forming free radicals preferentially degrades or carbon-carbon crosslinks. The present invention permits suppression of the preferential reaction while permitting the polymer to be carbon-FRTS-carbon crosslinked through a free-radical trapping species. Suppressing the undesirable degradation or carbon-carbon crosslinking reaction and permitting the desirable carbon-FRTS-carbon crosslinking reaction yield a uniquely crosslinked polymer.

### FIELD OF THE INVENTION

This invention relates to polymer systems that undergo free radical reactions, wherein introducing a unique free-radical-initiated crosslink is desirable.

### DESCRIPTION OF THE PRIOR ART

A number of polymers can undergo free radical reactions. Some of those reactions are detrimental such as degrading or carbon-carbon crosslinking. There is a need to promote a beneficial free-radical-initiated crosslinking reaction while minimizing the impact of the detrimental reactions.

Polyolefins are frequently subjected to nonselective free-radical chemistries. For example, free-radical chemistries at elevated temperatures can degrade the molecular weight, especially in polymers containing tertiary hydrogen such as polypropylene and polystyrene. Additionally, free-radical chemistries can promote carbon-carbon crosslinking, resulting in crosslinked polymers with limited physical properties.

With regard to polypropylene, the free-radical degradation of the polymer may be described as chain scission, lowers the polymer's molecular weight, and increases its melt flow rate. Because scission is not uniform, molecular weight distribution increases as lower molecular weight polymer chains referred to in the art as “tails” are formed.

With regard to polyethylene, the free-radical carbon-carbon crosslinking yield a crosslinked polymer with limited physical properties. It is desirable to introduce a unique crosslink and provide a crosslinked polymer with unique physical properties.

It is desirable to prepare a free-radical crosslinked polymer, without chain scission or carbon-carbon crosslinking the polymer. If the polymer is halogenated, it is also desirable that the polymer not undergo dehydrohalogenation.

It is also desirable to control the molecular architecture of the polymer as it undergoes the crosslinking reaction.

### SUMMARY OF THE INVENTION

The present invention is a free-radical carbon-FRTS-carbon crosslinkable polymeric composition. The resulting carbon-FRTS-carbon crosslinked polymer is prepared from at least one polymer which upon forming free radicals preferentially degrades or carbon-carbon crosslinks. The present invention permits suppression of the preferential reaction while permitting the polymer to be carbon-FRTS-carbon crosslinked through a free-radical trapping species. Suppressing the undesirable degradation or carbon-carbon crosslinking reaction and permitting the desirable carbon-FRTS-carbon crosslinking reaction yield a uniquely crosslinked polymer.

The present invention is useful in wire-and-cable, footwear, film (e.g. greenhouse, shrink, and elastic), engineering thermoplastic, highly-filled, flame retardant, reactive compounding, thermoplastic elastomer, thermoplastic vulcanizate, automotive, vulcanized rubber replacement, construction, automotive, furniture, foam, wetting, adhesive, paintable substrate, dyeable polyolefin, moisture-cure, nanocomposite, compatibilizing, wax, calendared sheet, medical, dispersion, coextrusion, cement/plastic reinforcement, food packaging, non-woven, paper-modification, multilayer container, sporting good, oriented structure, and surface treatment applications.

### BRIEF DESCRIPTION OF DRAWING

FIG. 1 shows torque-time curves at 182 degrees Celsius for free-radical-initiated crosslinkable polymeric compositions with and without a multifunctional free-radical trapping species.

FIG. 2 shows torque-time curves at 182 degrees Celsius for free-radical-initiated crosslinkable polymeric compositions with a multifunctional free-radical trapping species.

FIG. 3 shows torque-time curves at 182 degrees Celsius for free-radical-initiated crosslinkable polymeric compositions with and without a multiflnctional free-radical trapping species.

### DESCRIPTION OF THE INVENTION

“Carbon-FRTS-Carbon Coupling Bond,” as used herein, means covalent bonds formed between a carbon of a polymer molecule, a free-radical trapping species, and a carbon of another polymer molecule. Prior to formation of the carbon-FRTS-carbon coupling bond (crosslink), the free-radical trapping species has at least two trapping sites. At two of the trapping sites, the free-radical trapping species is grafted to the polymer molecules.

Preferably, the resulting carbon-FRTS-carbon crosslinked polymer will have a gel content as measured by xylene extraction (ASTM 2765) of greater than about 10 weight percent, more preferably, greater than about 30 weight percent, even more preferably, greater than about 50 weight percent, and most preferably, greater than about 70 weight percent. The gel content of the carbon-FRTS-carbon crosslinked polymer will be at least an absolute 10 weight percent greater than the gel content of the base polymer (the uncrosslinked polymer).

Alternatively, the crosslinking density of the carbon-FRTS-carbon crosslinked polymer will be determined based of the polymer's modulus. A carbon-FRTS-carbon crosslinked polymer will preferably have a Maximum Torque of at least about 1.30 times its Minimum Torque, both measured by a moving die rheometer at the crosslinking temperature of the polymer, a frequency of 100 cycles per minutes, and an arc of 0.5 degrees.
MH_{H}≧1.30×M_{L}
More preferably, the ultimate crosslinking density is achieved when the polymer's Maximum Torque is also about the same as its Final Torque at the crosslinking temperature.

“Constrained geometry catalyst catalyzed polymer”, “CGC-catalyzed polymer” or similar term, as used herein, means any polymer that is made in the presence of a constrained geometry catalyst. “Constrained geometry catalyst” or “CGC,” as used herein, has the same meaning as this term is defined and described in U.S. Pat. Nos. 5,272,236 and 5,278,272.

“Metallocene,” as used herein, means a metal-containing compound having at least one substituted or unsubstituted cyclopentadienyl group bound to the metal. “Metallocene-catalyzed polymer” or similar term means any polymer that is made in the presence of a metallocene catalyst.

“Polymer,” as used herein, means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

“P/E* copolymer” and similar terms, as used herein, means a propylene/unsaturated comonomer copolymer characterized as having at least one of the following properties: (i) ¹³C NMR peaks corresponding to a regio-error at about 14.6 and about 15.7 ppm, the peaks of about equal intensity and (ii) a differential scanning calorimetry (DSC) curve with a Tₘₑ that remains essentially the same and a Tₚₑₐₖ that decreases as the amount of comonomer, i.e., the units derived from ethylene and/or the unsaturated comonomer(s), in the copolymer is increased. “Tₘₑ ” means the temperature at which the melting ends. “Tₚₑₐₖ ” means the peak melting temperature. Typically, the copolymers of this embodiment are characterized by both of these properties. Each of these properties and their respective measurements are described in detail in U.S. patent application Ser. No. 10/139,786, filed May 5, 2002 (WO2003040442) which is incorporated herein by reference.

These copolymers can be further characterized further as also having a skewness index, Sᵢₓ, greater than about −1.20. The skewness index is calculated from data obtained from temperature-rising elution fractionation (TREF). The data is expressed as a normalized plot of weight fraction as a function of elution temperature. The molar content of isotactic propylene units that primarily determines the elution temperature.

A prominent characteristic of the shape of the curve is the tailing at lower elution temperature compared to the sharpness or steepness of the curve at the higher elution temperatures. A statistic that reflects this type of asymmetry is skewness. Equation 1 mathematically represents the skewness index, Sᵢₓ, as a measure of this asymmetry.

$${S}_{ix} = \frac{\sqrt[3]{\sum {w}_{i} * {( {T}_{i} - {T}_{Max} )}^{3}}}{\sqrt{\sum {w}_{i} * {( {T}_{i} - {T}_{Max} )}^{2}}} . \qquad Equation 1$$

The value, Tₘₐₓ, is defined as the temperature of the largest weight fraction eluting between 50 and 90 degrees C. in the TREF curve. Tᵢ and wᵢ are the elution temperature and weight fraction respectively of an arbitrary, i^{th} fraction in the TREF distribution. The distributions have been normalized (the sum of the wi equals 100%) with respect to the total area of the curve eluting above 30 degrees C. Thus, the index reflects only the shape of the crystallized polymer. Any uncrystallized polymer (polymer still in solution at or below 30 degrees C.) is omitted from the calculation shown in Equation 1.

The unsaturated comonomers for P/E* copolymers include C₄₋₂₀ α-olefins, especially C₄₋₁₂ α-olefins such as 1-butene, 1-pentene, 1-hexene, 4-methyl-1-pentene, 1-heptene, 1-octene, 1-decene, 1-dodecene and the like; C₄₋₂₀ diolefins, preferably 1,3-butadiene, 1,3-pentadiene, norbomadiene, 5-ethylidene-2-norbomene (ENB) and dicyclopentadiene; C₈₋₄₀ vinyl aromatic compounds including sytrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene. Ethylene and the C₄₋₁₂ α-olefins are the preferred comonomers, and ethylene is an especially preferred comonomer.

P/E* copolymers are a unique subset of P/E copolymers. P/E copolymers include all copolymers of propylene and an unsaturated comonomer, not just P/E* copolymers. P/E copolymers other than P/E* copolymers include metallocene-catalyzed copolymers, constrained geometry catalyst catalyzed copolymers, and Z-N-catalyzed copolymers. For purposes of this invention, P/E copolymers comprise 50 weight percent or more propylene while EP (ethylene-propylene) copolymers comprise 51 weight percent or more ethylene. As here used, “comprise . . . propylene”, “comprise . . . ethylene” and similar terms mean that the polymer comprises units derived from propylene, ethylene or the like as opposed to the compounds themselves.

“Propylene homopolymer” and similar terms mean a polymer consisting solely or essentially all of units derived from propylene. “Polypropylene copolymer” and similar terms mean a polymer comprising units derived from propylene and ethylene and/or one or more unsaturated comonomers.

“Ziegler-Natta-catalyzed polymer,” “Z-N-catalyzed polymer,” or similar term means any polymer that is made in the presence of a Ziegler-Natta catalyst.

In one embodiment, the present invention is a free-radical carbon-FRTS-carbon crosslinkable polymeric composition, which comprises a free-radical degradable polymer, a free-radical inducing species, and a free radical trapping species having at least two trapping sites. The polymer is capable of forming free radicals when induced by the free-radical inducing species.

In the absence of the free-radical trapping species and when induced by the free-radical inducing species, the polymer undergoes a degradation reaction in the presence of the free-radical inducing species. The degradation reaction can be chain scission or dehydrohalogenation. The free radical trapping species substantially suppresses the degradation reaction.

At the trapping sites, the free-radical trapping species is graftable onto the polymer after the polymer forms a free radical. A free-radical carbon-FRTS-carbon crosslinked polymer is yielded. Preferably, the free-radical carbon-FRTS-carbon crosslinked polymer will be substantially homogeneously crosslinked.

A variety of free-radical degradable polymers is useful in the present invention as the polymer. The free-radical degradable polymer can be hydrocarbon-based. Suitable free-radical degradable, hydrocarbon-based polymers include butyl rubber, polyacrylate rubber, polyisobutene, propylene homopolymers, propylene copolymers, styrene/butadiene/styrene block copolymers, styrene/ethylene/butadiene/styrene copolymers, polymers of vinyl aromatic monomers, vinyl chloride polymers, and blends thereof.

Preferably, the free-radical degradable, hydrocarbon-based polymer is selected from the group consisting of isobutene, propylene, and styrene polymers.

Preferably, the butyl rubber of the present invention is a copolymer of isobutylene and isoprene. The isoprene is typically used in an amount between about 1.0 weight percent and about 3.0 weight percent.

Examples of propylene polymers useful in the present invention include propylene homopolymers and P/E copolymers. In particular, these propylene polymers include polypropylene elastomers. The propylene polymers can be made by any process and can be made by Zeigler-Natta, CGC, metallocene, and nonmetallocene, metal-centered, heteroaryl ligand catalysis.

Useful propylene copolymers include random, block and graft copolymers. Exemplary propylene copolymers include Exxon-Mobil VISTAMAX, Mitsui TAFMER, and VERSIFY™ by The Dow Chemical Company. The density of these copolymers is typically at least about 0.850, preferably at least about 0.860 and more preferably at least about 0.865, grams per cubic centimeter (g/cm³).

Typically, the maximum density of these propylene copolymers is about 0.915, preferably the maximum is about 0.900 and more preferably the maximum is about 0.890 g/cm³. The weight average molecular weight (Mw) of these propylene copolymers can vary widely, but typically it is between about 10,000 and 1,000,000. The polydispersity of these copolymers is typically between about 2 and about 4.

These propylene copolymers typically have a melt flow rate (MFR) of at least about 0.01, preferably at least about 0.05, and more preferably at least about 0.1. The maximum MFR typically does not exceed about 2,000, preferably it does not exceed about 1000, more preferably it does not exceed about 500, further more preferably it does not exceed about 80 and most preferably it does not exceed about 50. MFR for copolymers of propylene and ethylene and/or one or more C₄-C₂₀ α-olefins is measured according to ASTM D-1238, condition L (2.16 kg, 230 degrees C.).

Styrene/butadiene/styrene block copolymers useful in the present invention are a phase-separated system. Styrene/ethylene/butadiene/styrene copolymers are also useful in the present invention.

Polymers of vinyl aromatic monomers are useful in the present invention. Suitable vinyl aromatic monomers include, but are not limited to, those vinyl aromatic monomers known for use in polymerization processes, such as those described in U.S. Pat. Nos. 4,666,987; 4,572,819 and 4,585,825.

Preferably, the monomer is of the formula: 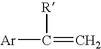
wherein R′ is hydrogen or an alkyl radical containing three carbons or less, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, vinyl anthracene and the like, and mixtures thereof.

The vinyl aromatic monomers may also be combined with other copolymerizable monomers. Examples of such monomers include, but are not limited to acrylic monomers such as acrylonitrile, methacrylonitrile, methacrylic acid, methyl methacrylate, acrylic acid, and methyl acrylate; maleimide, phenylmaleimide, and maleic anhydride. In addition, the polymerization may be conducted in the presence of predissolved elastomer to prepare impact modified, or grafted rubber containing products, examples of which are described in U.S. Pat. Nos. 3,123,655, 3,346,520, 3,639,522, and 4,409,369.

The present invention is also applicable to the rigid, matrix or continuous phase polymer of rubber-modified monovinylidene aromatic polymer compositions.

Useful free-radical inducing species include organic peroxides, Azo free radical initiators, and bicumene. Preferably, the free-radical inducing species is an organic peroxide. Also, oxygen-rich environments are preferred for initiating useful free-radicals. Preferable organic peroxides include dicumyl peroxide, Vulcup R, and dialkyl peroxides. More preferable, the organic peroxide is a dialkyl peroxide selected from the group consisting of 2,5-bis(tert-butylperoxy)-2,5-dimethylhexane and 2,5-bis(tert-butylperoxy)-2,5-dimethyl-3-hexyne. Most preferably, the organic peroxide is 2,5-bis(tert-butylperoxy)-2,5-dimethyl-3-hexyne.

The organic peroxide can be added via direct injection. Preferably, the free-radical inducing species is present in an amount between about 0.5 weight percent and about 20.0 weight percent, more preferably, between about 1.0 weight percent and about 15.0 weight percent, and most preferably, between about 1.5 weight percent and about 10.0 weight percent.

In addition to or as alternative to the free-radical inducing species, the polymer can form free radicals when subjected to shear energy, heat, or radiation. Accordingly, shear energy, heat, or radiation can act as free-radical inducing species. Moreover, the free-radical trapping species can act in the presence of free-radicals generated by shear energy, heat, or radiation as the free-radical trapping species would act in the presence of free radicals generated by the previously-described free-radical inducing species.

It is believed that when the free-radicals are generated by an organic peroxide, oxygen, air, shear energy, heat, or radiation, the combination of the free-radical trapping species and the source of free-radical is required for carbon-FRTS-carbon crosslinking of the polymer. Control of this combination determines the molecular architecture of the crosslinked polymer. Sequential addition of the free-radical trapping species followed by gradual initiation of free radicals provides an unprecedented degree of control over the molecular architecture.

It is also believed that grafting sites can be initiated on the polymer and capped with the free-radical trapping species to form a pendant stable free radical. Later, the pendant stable free radical can carbon-FRTS-carbon crosslink with a subsequently formed free radical, imparting desired levels of homogeneity to the resulting carbon-FRTS-carbon crosslinked polymer.

Examples of the free radical trapping species useful in the present invention include hindered amine-derived stable organic free radicals. Preferably, when the free radical trapping species is a hindered amine-derived stable organic free radical, it is selected from the group consisting of multi-functional molecules having at least two functional groups of 2,2,6,6,-tetramethyl piperidinyl oxy (TEMPO) and derivatives thereof. More preferably, the stable organic free radical is a bis-TEMPO. An example of a bis-TEMPO is bis(l-oxyl-2,2,6,6-tetramethylpiperidine-4-yl)sebacate. Also, even more preferably, the stable organic free radical is a multi-functional molecule having at least two nitroxyl groups derived from oxo-TEMPO, hydroxy-TEMPO, an ester of hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or a metal complex with TEMPO.

Preferably, the free radical trapping species is present in an amount between about 0.5 weight percent and about 20.0 weight percent, more preferably, between about 1.0 weight percent and about 15.0 weight percent, most preferably, between about 1.5 weight percent and about 10.0 weight percent.

Preferably, the ratio of the free-radical inducing species to the free radical trapping species and the concentration of the free-radical trapping species promote carbon-FRTS-carbon crosslinking of the polymer. More preferably, the free-radical inducing species to the free-radical trapping species are present in a ratio greater than about 1, more preferably, between about 20:1 to about 1:1.

The free-radical trapping species and the free-radical inducing species can be combined with the polymer in a variety of ways, including direct compounding, direct soaking, and direct injection.

In an alternate embodiment, the present invention is a free-radical carbon-FRTS-carbon crosslinkable polymeric composition, which comprises a free-radical carbon-carbon crosslinkable polymer, a free-radical inducing species, and a free radical trapping species having at least two trapping sites. The polymer is capable of forming free radicals when induced by the free-radical inducing species.

In the absence of the free-radical trapping species and when induced by the free-radical inducing species, the polymer undergoes a carbon-carbon crosslinking reaction. The free radical trapping species substantially suppresses the carbon-carbon crosslinking reaction.

At the trapping sites, the free-radical trapping species is graftable onto the polymer after the polymer forms a free radical. A free-radical carbon-FRTS-carbon crosslinked polymer is yielded. Preferably, the free-radical carbon-FRTS-carbon crosslinked polymer will be substantially homogeneously crosslinked.

A variety of free-radical carbon-carbon crosslinkable polymers is useful in the present invention as the polymer. The free-radical carbon-carbon crosslinkable polymer can be hydrocarbon-based. Suitable free-radical carbon-carbon crosslinkable, hydrocarbon-based polymers include acrylonitrile butadiene styrene rubber, chloroprene rubber, chlorosulfonated polyethylene rubber, ethylene/alpha-olefin copolymers, ethylene/diene copolymer, ethylene homopolymers, ethylene/propylene/diene monomers, ethylene/propylene rubbers, ethylene/styrene interpolymers, ethylene/unsaturated ester copolymers, fluoropolymers, halogenated polyethylenes, hydrogenated nitrile butadiene rubber, natural rubber, nitrile rubber, polybutadiene rubber, silicone rubber, styrene/butadiene rubber, styrene/butadiene/styrene block copolymers, styrene/ethylene/butadiene/styrene copolymers, and blends thereof.

For the present invention, chloroprene rubbers are generally polymers of 2-chloro-1,3-butadiene. Preferably, the rubber is produced by an emulsion polymerization. Additionally, the polymerization can occur in the presence of sulfur to incorporate crosslinking in the polymer.

Preferably, the free-radical carbon-carbon crosslinkable, hydrocarbon-based polymer is an ethylene polymer.

With regard to the suitable ethylene polymers, the polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1 -butene, 4-methyl-1-pentene, 1-hexene, and 1-octene.

Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-i-pentene, 1-hexene, and 1-octene. Most preferred are ethylene and a combination of ethylene with propylene or C₄-₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Natural rubbers suitable in the present invention include high molecular weight polymers of isoprene. Preferably, the natural rubber will have a number average degree of polymerization of about 5000 and a broad molecular weight distribution.

Preferably, the nitrile rubber of the present invention is a random copolymer of butadiene and acrylonitrile.

The polybutadiene rubber useful in the present invention is preferably a homopolymer of 1,4-butadiene.

Useful styrene/butadiene rubbers include random copolymers of styrene and butadiene. Typically, these rubbers are produced by free radical polymerization. Styrene/butadiene/styrene block copolymers of the present invention are a phase-separated system. The styrene/ethylene/butadiene/styrene copolymers are also useful in the present invention.

Useful free-radical inducing species include organic peroxides, Azo free radical initiators, and bicumene. Preferably, the free-radical inducing species is an organic peroxide. Also, oxygen-rich environments are preferred for initiating useful free-radicals. Preferable organic peroxides include dicumyl peroxide, Vulcup R, and dialkyl peroxides. More preferable, the organic peroxide is a dialkyl peroxide selected from the group consisting of 2,5-bis(tert-butylperoxy)-2,5-dimethylhexane and 2,5-bis,(tert-butylperoxy)-2,5-dimethyl-3-hexyne. Most preferably, the organic peroxide is 2,5-bis(tert-butylperoxy)-2,5-dimethyl-3-hexyne.

The organic peroxide can be added via direct injection. Preferably, the free-radical inducing species is present in an amount between about 0.5 weight percent and about 20.0 weight percent, more preferably, between about 1.0 weight percent and about 15.0 weight percent, and most preferably, between about 1.5 weight percent and about 10.0 weight percent.

In addition to or as alternative to the free-radical inducing species, the polymer can form free radicals when subjected to shear energy, heat, or radiation. Accordingly, shear energy, heat, or radiation can act as free-radical inducing species. Moreover, the free-radical trapping species can act in the presence of free-radicals generated by shear energy, heat, or radiation as the free-radical trapping species would act in the presence of free radicals generated by the previously-described free-radical inducing species.

It is believed that when the free-radicals are generated by an organic peroxide, oxygen, air, shear energy, heat, or radiation, the combination of the free-radical trapping species and the source of free-radical is required for carbon-FRTS-carbon crosslinking of the polymer. Control of this combination determines the molecular architecture of the carbon-FRTS-carbon crosslinked polymer. Sequential addition of the free-radical trapping species followed by gradual initiation of free radicals provides an unprecedented degree of control over the molecular architecture.

It is also believed that grafting sites can be initiated on the polymer and capped with the free-radical trapping species to form a pendant stable free radical. Later, the pendant stable free radical can carbon-FRTS-carbon crosslink with a subsequently formed free radical, imparting desired levels of homogeneity to the resulting carbon-FRTS-carbon crosslinked polymer.

In yet another embodiment, the present invention is a free-radical carbon-FRTS-carbon crosslinkable polymeric composition, which comprises (1) a polymer selected from the group consisting of free-radical degradable polymers and free-radical carbon-carbon crosslinkable polymers and (2) a pendant stable free radical.

The pendant stable free radical is derived from grafting a free radical trapping species onto the polymer. Prior to forming the pendant stable free radical, the free radical trapping species had at least two trapping sites. After its formation, the pendant stable free radical has at least one trapping site.

The polymer is capable of forming free radicals when induced by a free-radical inducing species. In the absence of the pendant stable free radical and when induced by a free-radical inducing species, the polymer is capable of forming free radicals and preferentially undergoes an undesirable reaction. The undesirable reaction is a degradation reaction or a carbon-carbon crosslinking reaction.

In the free-radical carbon-FRTS-carbon crosslinkable polymeric composition, the undesirable reaction is substantially suppressed.

At the trapping sites, the pendant stable free radical is graftable onto the polymer after the polymer forms a free radical. A free-radical carbon-FRTS-carbon crosslinked polymer is yielded. The carbon-FRTS-carbon crosslinked polymer comprises the polymer crosslinked to the pendant stable free radical. Preferably, the free-radical carbon-FRTS-carbon crosslinked polymer will be substantially homogeneously coupled.

The free-radical trapping species and the free-radical inducing species can be combined with the polymer in a variety of ways, including direct compounding, direct soaking, and direct injection.

In an alternate embodiment, the present invention is a process for preparing a free-radical carbon-FRTS-carbon crosslinkable polymer. The first step of the process is preparing a polymer-matrix mixture by mixing its components. The components include a free-radical degradable polymer, a free-radical inducing species, and a free radical trapping species having at least two trapping sites. The free radical trapping species substantially suppresses the degradation reaction. In the second step, the polymer is grafted through the free-radical trapping species.

In this embodiment, it is possible to control the molecular architecture of the resulting free-radical carbon-FRTS-carbon crosslinked polymer. To do so, the rate of adding the free-radical inducing species in the first step should (1) be controlled and (2) follows the addition or occur simultaneously with the addition of the free-radical trapping species. Preferably, the free-radical inducing species will be added following addition of the free-radical trapping species (that is, in a second step and the grafting will occur in a third step).

It is possible to substitute a pendant stable free radical for the free-radical trapping species. To that end, the free-radical trapping species can be separately grafted onto the polymer to form a pendant stable free radical in an inert atmosphere. The polymer matrix will then include the polymer, the pendant stable free radical, and a free-radical inducing species.

In an alternate embodiment, the present invention is a process for preparing a free-radical carbon-FRTS-carbon crosslinkable polymer. The first step of the process is preparing a polymer-matrix mixture by mixing its components. The components include a free-radical carbon-carbon crosslinkable polymer, a free-radical inducing species, and a free radical trapping species having at least two trapping sites. The free radical trapping species substantially suppresses the carbon-carbon crosslinking reaction. In the second step, the polymer is grafted through the free-radical trapping species.

In this embodiment, it is possible to control the molecular architecture of the resulting free-radical carbon-FRTS-carbon crosslinked polymer. To do so, the rate of adding the free-radical inducing species in the first step should (1) be controlled and (2) follows the addition or occur simultaneously with the addition of the free-radical trapping species. Preferably, the free-radical inducing species will be added following addition of the free-radical trapping species (that is, in a second step and the grafting will occur in a third step).

It is possible to substitute a pendant stable free radical for the free-radical trapping species. To that end, the free-radical trapping species can be separately grafted onto the polymer to form a pendant stable free radical in an inert atmosphere. The polymer matrix will then include the polymer, the pendant stable free radical, and a free-radical inducing species.

In a preferred embodiment, the present invention is an article of manufacture prepared from the free-radical carbon-FRTS-carbon crosslinkable polymer composition. Any number of processes can be used to prepare the articles of manufacture. Specifically useful processes include injection molding, extrusion, compression molding, rotational molding, thermoforming, blowmolding, powder coating, Banbury batch mixers, fiber spinning, and calendaring.

Suitable articles of manufacture include wire-and-cable insulations, wire-and-cable semiconductive articles, wire-and-cable coatings and jackets, cable accessories, shoe soles, multicomponent shoe soles (including polymers of different densities and type), weather stripping, gaskets, profiles, durable goods, rigid ultradrawn tape, run flat tire inserts, construction panels, composites (e.g., wood composites), pipes, foams, blown films, and fibers (including binder fibers and elastic fibers).

### EXAMPLES

The following non-limiting examples illustrate the invention.

### Comparative Examples 1-3 and Examples 4-5

Three comparative examples and two examples of the present invention were prepared with a polypropylene elastomer, having an ethylene content of 15 weight percent, a melt flow rate of 2 grams per 10 minutes, and a density of 0.858 grams per cubic centimeter. The melt flow rate was measured at 230 degrees Celsius according to ASTM D-1238.

Each of the formulations shown in Table I, excluding the peroxide, was prepared in a Brabender mixer to make 40 grams samples at 110 degrees Celsius for 3 minutes. The peroxide was subsequently added. The composition was compounded for 4 additional minutes.

The PROSTAB™ 5415 bis(1-oxyl-2,2,6,6-tetramethylpiperidine-4-yl)sebacate (the “bis-TEMPO”) was commercially available from the Ciba Specialty Chemicals, Inc. The Luperox™ 130 2,5-Bis(tert-butylperoxy)-2,5-dimethyl-3-hexyne organic peroxide was commercially available from Atofina.

The reaction kinetics were investigated using a moving die rheometer (MDR) at 182 degrees Celsius. Tensile strength and hot creep were measured on plaques of 0.03 inch (30 mil) thickness that were prepared by compression molding for 10 minutes at 110 degrees Celsius, followed by 70 minutes at 180 degrees Celsius. Tensile strength (stress at maximum load) was determined at room temperature in accordance with ASTM D638-00 (at displacement rate of 2 inch/minute). Hot Creep properties were determined at three different temperatures (50, 100 and 150 degrees Celsius) in accordance with ICEA Publication T-28-562-1995 (“Test Method for Measurement of Hot Creep of Polymeric Insulations” dated March 1995 from Insulated Cable Engineers Association, Inc). When the test specimen without breaking achieved the maximum limits of the testing equipment for Hot Creep, the results were reported as maximum. The results are reported in Table I.

For each evaluated composition, the MDR generated torque versus time data. In addition to the set temperature of 182 degrees Celsius, the MDR was set for a frequency of 100 cycles per minute and an arc of 0.5 degrees. The test specimens weighed about 5 grams and were placed between Mylar™ sheets and then into the MDR for evaluation. The set temperature and evaluation time were set depending on the end-use application and the composition.

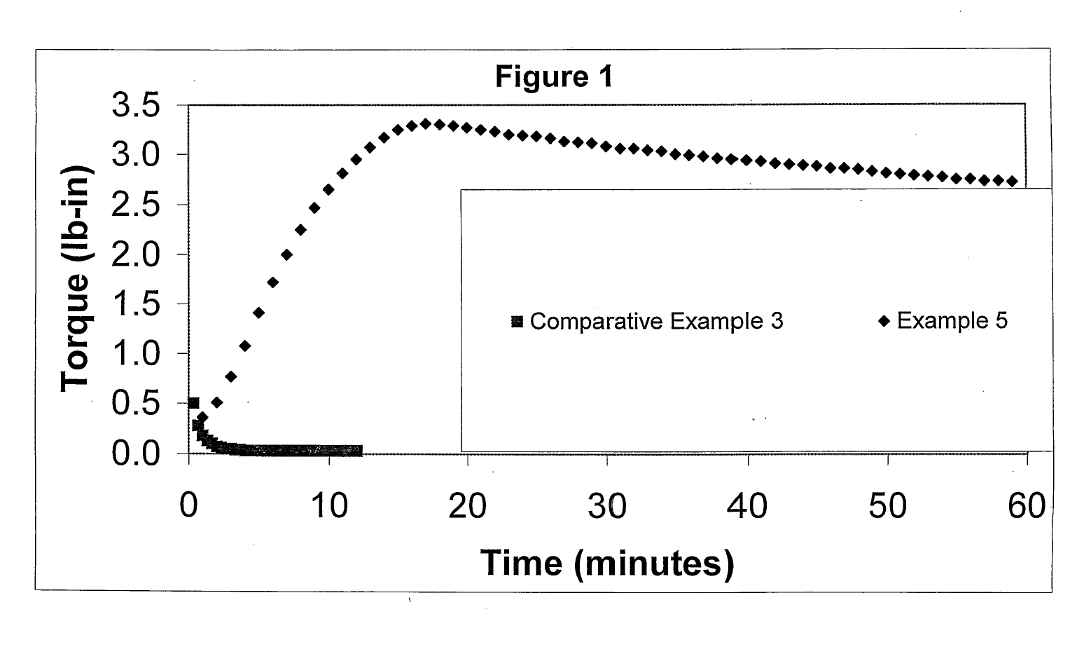

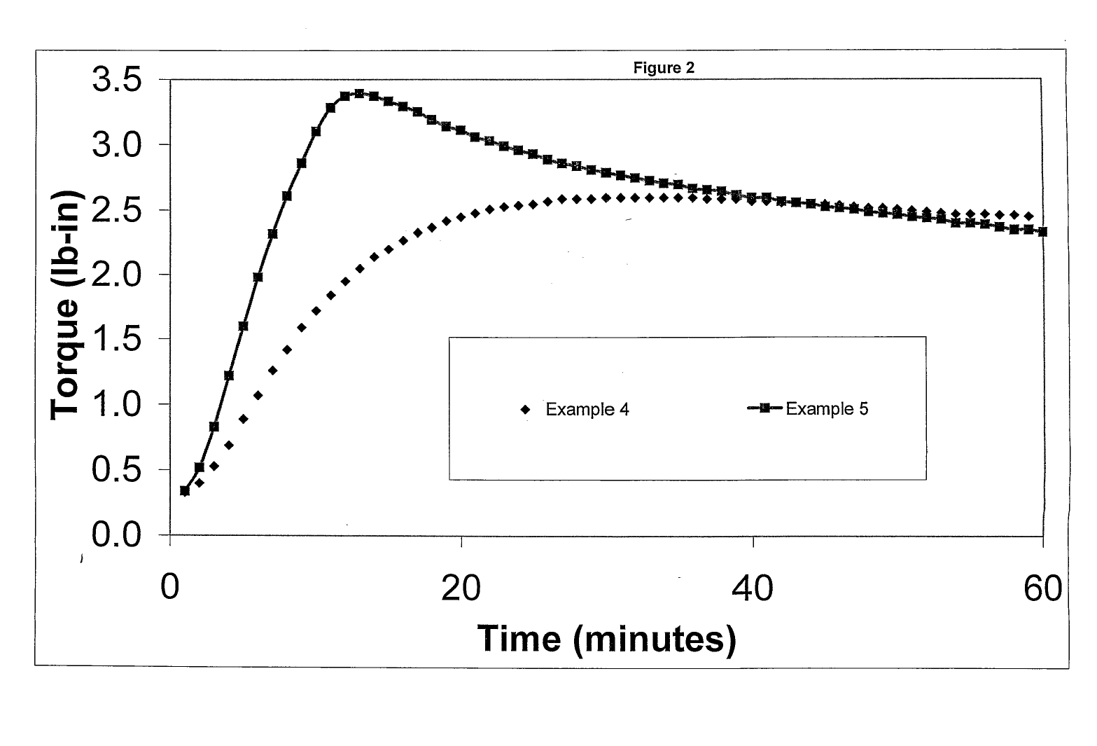

FIG. 1 showed torque-time curves at 182 degrees Celsius for Comparative Example 3 and Example 5. FIG. 2 show torque-time curves at 182 degrees Celsius for Examples 4 and 5.

TABLE I

| Component | C. Ex. 1 | C. Ex. 2 | C. Ex. 3 | Ex. 4 | Ex. 5 |
|---|---|---|---|---|---|
| polypropylene | 100.0 | 98.75 | 98.0 | 95.75 | 95.0 |
| bis-TEMPO | | | | 3.0 | 3.0 |
| Luperox 130 | | 1.25 | 2.0 | 1.25 | 2.0 |

Tensile Strength (pounds per square inch (psi))

| | | | | |
|---|---|---|---|---|
| room temperature | 1316 | 997 | 1267 | 1086 |

Enhanced Hot Creep (20 N/cm², 15 minutes)

| | | | | |
|---|---|---|---|---|
| 50 degrees Celsius | 119.16 | Maximum | 50.92 | 37.80 |
| 100 degrees Celsius | Broke | Broke | Maximum | 279.27 |
| 150 degrees Celsius | Broke | Broke | Maximum | 264.17 |

### Comparative Examples 6-8 and Examples 9-12

Three comparative examples and four examples were prepared with a polypropylene elastomer, having an ethylene content of 15 weight percent, a melt flow rate of 2 grams per 10 minutes, and a density of 0.858 grains per cubic centimeter. The melt flow rate was measured at 230 degrees Celsius according to ASTM D-1238.

Each of the formulations shown in Table II, excluding the peroxide, was prepared in a Brabender mixer to make 40 grams samples at 110 degrees Celsius for 3 minutes. The peroxide was subsequently added. The composition was compounded for 4 additional minutes.

The PROSTAB™ 5415 bis-TEMPO was commercially available from the Ciba Specialty Corporation. The Dicup R™ organic peroxide was commercially available from Geo Specialty Chemicals while the Luperox™ 130 organic peroxide was commercially available from Atofina.

The reaction kinetics were investigated using a moving die rheometer (MDR) at 182 degrees Celsius. The results are reported in Table II.

For each evaluated composition, the MDR generated torque versus time data. In addition to the set temperature of 182 degrees Celsius, the MDR was set for a frequency of 100 cycles per minute and an arc of 0.5 degrees. The test specimens weighed about 5 grams and were placed between Mylar™ sheets and then into the

MDR for evaluation. The set temperature and evaluation time were set depending on the end-use application and the composition.

TABLE II

| | C. | C. | C. | | | | |
|---|---|---|---|---|---|---|---|
| Component | Ex. 6 | Ex. 7 | Ex. 8 | Ex. 9 | Ex. 10 | Ex. 11 | Ex. 12 |
| polypropylene | 98.0 | 98.0 | 96.75 | 95.0 | 95.0 | 95.75 | 96.25 |
| bis-TEMPO | | | 3.0 | 3.0 | 3.0 | 3.0 | 3.0 |
| Dicup R | 2.0 | | | 2.0 | | | |
| Luperox 130 | | 2.0 | 0.25 | | 2.0 | 1.25 | 0.75 |

MDR: 182 degrees Celsius

| | | | | | | | |
|---|---|---|---|---|---|---|---|
| Time (minutes) | 12 | 12 | 120 | 12 | 60 | 60 | 60 |
| Minimum | 0.01 | 0.02 | 0.29 | 0.36 | 0.34 | 0.33 | 0.30 |
| Torque, M_{L} (lb- | | | | | | | |
| in) | | | | | | | |
| Maximum | 0.03 | 0.03 | 0.35 | 0.87 | 3.31 | 2.60 | 0.63 |
| Torque, M_{H} | | | | | | | |
| (lb-in) | | | | | | | |
| Final Torque, | 0.02 | 0.03 | 0.33 | 0.83 | 2.72 | 2.45 | 0.56 |
| M_{F} (lb-in) | | | | | | | |
| Onset of torque | N/A | N/A | 4.00 | 0.85 | 1.00 | 1.25 | 4.00 |
| increase (min) | | | | | | | |

### Comiparative Example 13 and Examples 14-17

A comparative example and four examples were prepared with a polypropylene elastomer, having an ethylene content of 12 weight percent, a melt flow rate of 8 grams per 10 minutes, and a density of 0.866 grams per cubic centimeter. The melt flow rate was measured at 230 degrees Celsius according to ASTM D-1238.

Each of the formulations shown in Table III, excluding the peroxide, was prepared in a preheated 300-cc Haake bowl at 100 degrees Celsius and allowed to melt. The bowl was sealed by the bowl ram, and the components were stirred at 40 rpm.

When the polymer melted as demonstrated by a recovering temperature and stabilized torque, the ram was raised. A nitrogen purge was introduced through a feed port into the bowl. The peroxide was added. Next, the ram was lowered into the feed port to seal the reaction vessel. The flow of nitrogen was discontinued.

When the temperature of the molten polymer composition reached the desired reaction temperature, the bowl was operated for three minutes. Next, the rotors were stopped, and the polymer mixture was removed, pressed into a flat patty, and allowed to cool to room temperature.

The test specimens were prepared by compression molding. The compositions were melted at 100 degrees Celsius for 3 minutes. Then, they were compression molded at 5.5 MPa for 2 minutes. Finally, the molded materials were quenched in a press equilibrated at room temperature.

Then, the test specimens were cured at 180 degrees Celsius in a compression molded press for 20 minutes.

Tensile strength (stress at maximum load) and tensile elongation (strain at break) were determined at room temperature in accordance with ASTM 1708 at a displacement rate of 5 inch/minute. The gel level was determined by xylene extraction (ASTM 2765). The results are reported in Table III.

The PROSTAB™ 5415 bis-TEMPO was commercially available from the Ciba Specialty Corporation. The Luperox™ 130 organic peroxide was commercially available from Atofina.

TABLE III

| Component | C. Ex. 13 | Ex. 14 | Ex. 15 | Ex. 16 | Ex. 17 |
|---|---|---|---|---|---|
| polypropylene | 100.0 | 97.2 | 95.4 | 94.4 | 90.8 |
| bis-TEMPO | | 1.8 | 3.6 | 3.6 | 7.2 |
| Luperox 130 | | 1.0 | 1.0 | 2.0 | 2.0 |
| Gel Content (%) | | 79 | 85 | 70 | 77 |
| Tensile Strength | 19 | 16 | 16 | 15 | 15 |
| (MPa) | | | | | |
| Tensile Elongation (%) | 1015 | 1001 | 903 | 910 | 881 |

### Comparative Example 18 and Examples 19-20

A comparative example and two examples were prepared with a propylene homopolymer, having a melt flow rate of 9 grams per 10 minutes and a density of 0.900 grams per cubic centimeter. The melt flow rate was measured at 230 degrees Celsius according to ASTM D-1238.

Each of the formulations shown in Table IV, excluding the peroxide, was prepared in a preheated 300-cc Haake bowl at 170 degrees Celsius and allowed to melt. The bowl was sealed by the bowl ram, and the components were stirred at 40 rpm.

When the polymer melted as demonstrated by a recovering temperature and stabilized torque, the ram was raised. A nitrogen purge was introduced through a feed port into the bowl. The peroxide was added. Next, the ram was lowered into the feed port to seal the reaction vessel. The flow of nitrogen was discontinued.

When the temperature of the molten polymer composition reached the desired reaction temperature, the bowl was operated for three minutes. Next, the rotors were stopped, and the polymer mixture was removed, pressed into a flat patty, and allowed to cool to room temperature.

The test specimens were prepared by compression molding. The compositions were melted at 170 degrees Celsius for 3 minutes. Then, they were compression molded at 5.5 MPa for 2 minutes. Finally, the molded materials were quenched in a press equilibrated at room temperature.

Then, the test specimens were cured at 180 degrees Celsius in a compression molded press for 20 minutes.

Tensile strength (stress at maximum load) and tensile elongation (strain at break) were determined at room temperature in accordance with ASTM 1708 at a displacement rate of 5 inch/minute. The gel level was determined by xylene extraction (ASTM 2765). The results are reported in Table IV.

The PROSTAB™ 5415 bis-TEMPO was commercially available from the Ciba Specialty Corporation. The Luperox™ 130 organic peroxide was commercially available from Atofina.

TABLE IV

| Component | C. Ex. 18 | Ex. 19 | Ex. 20 |
|---|---|---|---|
| polypropylene | 100.0 | 97.2 | 94.4 |
| bis-TEMPO | | 1.8 | 3.6 |
| Luperox 130 | | 1.0 | 2.0 |
| Gel Content (%) | | 57 | 89 |
| Tensile Strength (MPa) | 39 | 35 | 32 |
| Tensile Elongation (%) | 39 | 127 | 246 |

### Comparative Example 21 and Example 22

A comparative example and an example of the present invention were prepared with a polypropylene elastomer, having an ethylene content of 12 weight percent, a melt flow rate of 8 grams per 10 minutes, and a density of 0.866 grams per cubic centimeter. The melt flow rate was measured at 230 degrees Celsius according to ASTM D-1238.

Each of the formulations shown in Table V, excluding the peroxide, was prepared in a preheated 300-cc Haake bowl at 100 degrees Celsius and allowed to melt. The bowl was sealed by the bowl ram, and the components were stirred at 40 rpm.

When the polymer melted as demonstrated by a recovering temperature and stabilized torque, the ram was raised. A nitrogen purge was introduced through a feed port into the bowl. The peroxide was added. Next, the ram was lowered into the feed port to seal the reaction vessel. The flow of nitrogen was discontinued.

When the temperature of the molten polymer composition reached the desired reaction temperature, the bowl was operated for three minutes. Next, the rotors were stopped, and the polymer mixture was removed, pressed into a flat patty, and allowed to cool to room temperature.

The test specimens were then crosslinked using an e-beam crosslinking technique under nitrogen atmosphere and at 3.2 mRad per pass. The test specimens were allowed to cool to room temperature between successive e-beam passes. The number of passes is reported in Table V.

The gel level was determined by xylene extraction (ASTM 2765). The results are reported in Table III.

The PROSTAB™ 5415 bis-TEMPO was commercially available from the Ciba Specialty Corporation

TABLE V

| Component | C. Ex. 21 | Ex. 22 |
|---|---|---|
| polypropylene | 100.0 | 99.4 |
| bis-TEMPO | | 0.6 |
| Number of Passes | 9 | 6 |
| Gel Content (%) | 34 | 65 |

### Comparative Examples 23-28 and Examples 29-31

Six comparative examples and three examples of the present invention were prepared with a blended butyl rubber.

Each of the formulations shown in Table VI, excluding the peroxide, was prepared in a Brabender mixer to make 40 grams samples at a specified temperature for 3 minutes. (The temperature was either 95 degrees Celsius or 124 degrees Celsius. The temperature selected was to avoid slippage of the free-radical trapping species. The higher concentration of the free-radical trapping species required mixing at the lower temperature.) The peroxide was subsequently added. The composition was compounded for 4 additional minutes.

The G&E blended butyl rubber (CAS Number 9010-85-9) was commercially available from Goldsmith & Eggleton, Inc. The PROSTAB™ 5415 bis-TEMPO was commercially available from the Ciba Specialty Chemicals, Inc. The Luperox™ 130 2,5-Bis(tert-butylperoxy)-2,5-dimethyl-3-hexyne organic peroxide was commercially available from Atofina.

The reaction kinetics were investigated using a moving die rheometer (MDR) at 160 degrees Celsius, 182 degrees Celsius, and 200 degrees Celsius. The results are reported in Table VI.

For each evaluated composition, the MDR generated torque versus time data. In addition to the set temperature, the MDR was set for a frequency of 100 cycles per minute and an arc of 0.5 degrees. The test specimens weighed about 5 grams and were placed between Mylar™ sheets and then into the MDR for evaluation. The set temperature and evaluation time were set depending on the end-use application and the composition.

All materials retained good flexibility. That is, they were not brittle when handled.

TABLE VI

| Component | C. Ex. 23 | C. Ex. 24 | C. Ex. 25 | C. Ex. 26 | C. Ex. 27 | C. Ex. 28 | Ex. 29 | Ex. 30 | Ex. 31 |
|---|---|---|---|---|---|---|---|---|---|
| Butyl rubber | 99.25 | 98.75 | 98.0 | 96.25 | 95.75 | 95.0 | 90.0 | 87.0 | 85.0 |
| Bis-TEMPO | | | | 3.0 | 3.0 | 3.0 | 6.0 | 9.0 | 9.0 |
| Luperox 130 | 0.75 | 1.25 | 2.0 | 0.75 | 1.25 | 2.0 | 4.0 | 4.0 | 6.0 |
| Mixing Temperature (degrees Celsius) | 124 | 124 | 124 | 124 | 124 | 124 | 95 | 95 | 95 |

MDR: 160 degrees Celsius, 240 minutes

| | | | | | | | |
|---|---|---|---|---|---|---|---|
| Minimum Torque, M_{L} (lb-in) | 0.00 | 0.63 | 0.73 | 0.68 | 0.55 | 0.34 | 0.49 |
| Maximum Torque, M_{H} (lb-in) | 0.00 | 0.63 | 0.82 | 0.90 | 0.88 | 0.69 | 0.71 |
| Final Torque, M_{F} (lb-in) | 0.00 | 0.63 | 0.76 | 0.75 | 0.55 | 0.67 | 0.62 |
| M_{H}-M_{L} (lb-in) | 0.00 | 0.00 | 0.09 | 0.22 | 0.33 | 0.35 | 0.22 |
| M_{F}-M_{L} (lb-in) | 0.00 | 0.00 | 0.03 | 0.07 | 0.00 | 0.33 | 0.13 |
| Onset of torque increase (min) | | | | | 27.0 | 53.0 | 38.0 |

MDR: 182 degrees Celsius, 60 minutes

| | | | | | | | |
|---|---|---|---|---|---|---|---|
| Minimum Torque, M_{L} (lb-in) | 0.00 | 0.50 | 0.50 | 0.49 | 0.34 | 0.4 | 0.34 |
| Maximum Torque, M_{H} (lb-in) | 0.00 | 0.55 | 0.68 | 0.82 | 0.95 | 1.04 | 0.73 |
| Final Torque, M_{F} (lb-in) | 0.00 | 0.49 | 0.60 | 0.07 | 0.03 | 0.95 | 0.71 |
| M_{H}-M_{L} (lb-in) | 0.00 | 0.05 | 0.18 | 0.33 | 0.61 | 0.70 | 0.39 |
| M_{F}-M_{L} (lb-in) | 0.00 | −0.01 | 0.10 | −0.42 | −0.31 | 0.61 | 0.37 |
| Onset of torque increase (min) | | | | | 1.5 | 2.0 | 2.5 |

MDR: 200 degrees Celsius; 12 minutes

| | | | | | | | | | |
|---|---|---|---|---|---|---|---|---|---|
| Minimum Torque, M_{L} (lb-in) | 0.00 | 0.00 | 0.00 | 0.43 | 0.42 | 0.41 | 0.30 | 0.26 | 0.26 |
| Maximum Torque, M_{H} (lb-in) | 0.00 | 0.01 | 0.00 | 0.49 | 0.60 | 0.61 | 0.67 | 0.80 | 0.69 |
| Final Torque, M_{F} (lb-in) | 0.00 | 0.01 | 0.00 | 0.48 | 0.47 | 0.02 | 0.01 | 0.43 | 0.34 |
| M_{H}-M_{L} (lb-in) | 0.00 | 0.01 | 0.00 | 0.06 | 0.18 | 0.20 | 0.37 | 0.54 | 0.43 |
| M_{F}-M_{L} (lb-in) | 0.00 | 0.01 | 0.00 | 0.05 | 0.05 | −0.39 | −0.29 | 0.17 | 0.08 |
| Onset of torque increase (min) | | | | | | | 0.7 | 0.8 | 1.0 |

### Comparative Example 32 and Example 33

One comparative example and one examples of the present invention were prepared with a vinyl chloride/vinyl acetate/hydroxyl alkyl acrylate terpolymer, having a vinyl chloride content of 81 percent and a vinyl acetate content of 4 percent.

Each of the formulations, excluding the peroxide, was prepared in a Brabender mixer to make 40 grams samples at 125 degrees Celsius for 3 minutes. The peroxide was subsequently added. The composition was compounded for 4 additional minutes.

The Comparative Example 32 formulation contained 98 weight percent of the terpolymer and 2 weight percent of Luperox™ 130 organic peroxide. The Example 33 formulation contained 95 weight percent of the terpolymer, 2 weight percent of Luperox™ 130 organic peroxide, and 3 weight percent of PROSTAB™ 5415 bis-TEMPO.

The terpolymer was commercially available from The Dow Chemical Company as UCAR™ VAGC vinyl chloride/vinyl acetate/hydroxyl alkyl acrylate terpolymer. The PROSTAB™ 5415 bis-TEMPO was commercially available from the Ciba Specialty Chemicals, Inc. The Luperox™ 130 organic peroxide was commercially available from Atofina.

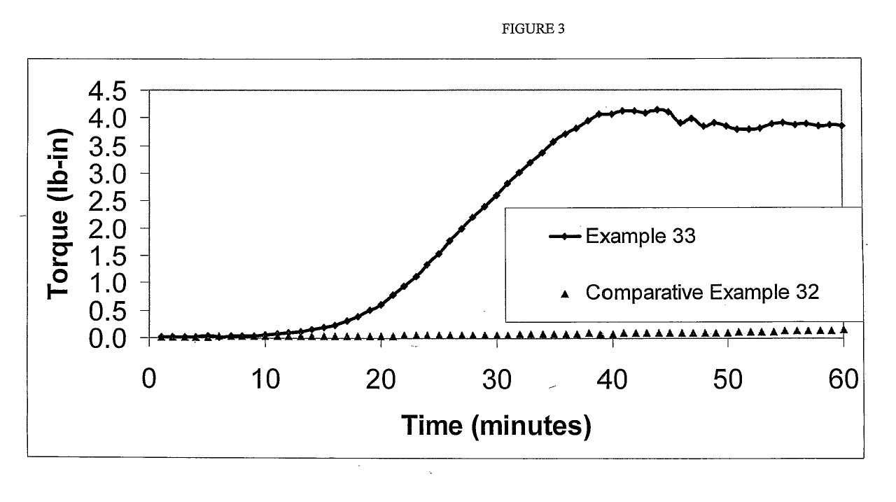

The reaction kinetics were investigated using a moving die rheometer (MDR). FIG. 3 showed torque-time curves at 182 degrees Celsius for Comparative Example 32 and Example 33.

### Comparative Examples 34-36 and Example 37-38

Three comparative examples and two examples of the present invention were prepared with a low density polyethylene, having a melt index of 2.4 g/10 minutes, I21/I2 of 52, a density of 0.9200 grams per cubic centimeter, a polydispersity (Mw/Mn) of 3.54, and a melting point of 110.2 degrees Celsius. Each of the formulations shown in Table IV, excluding the peroxide, was prepared in a Brabender mixer at 125 degrees Celsius for 3 minutes. The peroxide was subsequently added. The composition was compounded for 4 additional minutes.

The low density polyethylene was commercially available from The Dow Chemical Company. The PROSTAB™ 5415 bis-TEMPO was commercially available from the Ciba Specialty Corporation. The Luperox™ 130 organic peroxide was commercially available from Atofina.

The reaction kinetics were investigated using MDR at 200 degrees Celsius. Tensile strength and tensile elongation were measured on plaques of 0.05 inch (50 mil) thickness that were prepared by compression molding for 10 minutes at 125 degrees Celsius, followed by 70 minutes at 180 degrees Celsius. Tensile strength (stress at maximum load) and tensile elongation (strain at break) were determined at room temperature in accordance with ASTM D638-00 (at displacement rate of 2 inch/minute). The results are reported in Table VII.

TABLE VII

| Component | C. Ex. 34 | C. Ex. 35 | C. Ex. 36 | Ex. 37 | Ex. 38 |
|---|---|---|---|---|---|
| LDPE | 100 | 99.5 | 99.0 | 96.0 | 95.5 |
| bis-TEMPO | | | | 3.0 | 3.0 |
| Luperox 130 | | 0.5 | 1.0 | 1.0 | 1.5 |

MDR: 200 degrees Celsius

| | | | | |
|---|---|---|---|---|
| Time (minutes) | 10 | 20 | 20 | 20 |
| Minimum | 0.13 | 0.15 | 0.09 | 0.09 |
| Torque, M_{L} | | | | |
| (lb-in) | | | | |
| Maximum | 1.4 | 2.75 | 0.99 | 3.33 |
| Torque, M_{H} | | | | |
| (lb-in) | | | | |
| Final Torque, | 1.4 | 2.74 | 0.82 | 2.82 |
| M_{F (lb-in)} | | | | |
| M_{H}-M_{L} (lb-in) | 1.27 | 2.60 | 0.90 | 3.24 |
| M_{F}-M_{L} (lb-in) | 1.27 | 2.59 | 0.73 | 2.73 |
| Onset of torque | 0.50 | 0.60 | 1.00 | 0.80 |
| increase (min) | | | | |

Tensile Strength (pounds per square inch (psi))

| | | | | |
|---|---|---|---|---|
| room temperature | 1856 | 3322 | 3117 | 2919 |

Tensile Elongation (%)

| | | | | |
|---|---|---|---|---|
| room temperature | 531 | 435 | 534 | 457 |

1. A free-radical carbon-FRTS-carbon crosslinkable polymeric composition comprising:
(a) a free-radical degradable polymer,
(b) a free-radical inducing species, and
(c) a free radical trapping species having at least two trapping sites,
wherein
(A1) the free radical trapping species (i) substantially suppresses degradation of the polymer in the presence of the free-radical inducing species and (ii) at a trapping site, being graftable onto the polymer after the polymer forms a free radical, and
(A2) the free-radical carbon-FRTS-carbon crosslinkable composition yields a free-radical carbon-FRTS-carbon crosslinked polymer.

2. The free-radical carbon-FRTS-carbon crosslinkable polymeric composition of claim 1 wherein the degradation occurs by chain scission.

3. The free-radical carbon-FRTS-carbon crosslinkable polymeric composition of claim 1 wherein the polymer being halogenated and the degradation occurs by dehydrohalogenation.

4. The free-radical carbon-FRTS-carbon crosslinkable polymeric composition of claim 1 wherein the resulting free-radical carbon-FRTS-carbon crosslinked polymer having a gel content as measured by xylene extraction (ASTM 2765) of greater than about 10 weight percent.

5. The free-radical carbon-FRTS-carbon crosslinkable polymeric composition of claim 1 wherein the resulting carbon-FRTS-carbon polymer having a gel content as measured by xylene extraction (ASTM 2765) of at least about an absolute 10 weight percent greater than the gel content of the base polymer.

6. The free-radical carbon-FRTS-carbon crosslinkable polymeric composition of claim 1 wherein the polymer is selected from the group consisting of butyl rubber, polyacrylate rubber, polyisobutene, propylene homopolymers, propylene copolymers, styrene/butadiene/styrene block copolymers, styrene/ethylene/butadiene/styrene copolymers, polymers of vinyl aromatic monomers, vinyl chloride polymers, and blends thereof.

7. The free-radical carbon-FRTS-carbon crosslinkable polymeric composition of claim 1 wherein the free-radical inducing species being an organic peroxide, Azo free radical initiator, bicumene, oxygen, and air.

8. The free-radical carbon-FRTS-carbon crosslinkable polymeric composition of claim 1 wherein the free radical trapping species being a hindered amine-derived free radical trapping species.

9. The free-radical carbon-FRTS-carbon crosslinkable polymeric composition of claim 8 wherein the hindered amine-derived free radical trapping species being selected from the group consisting of multi-functional molecules having at least two functional groups of 2,2,6,6,-tetramethyl piperidinyl oxy and derivatives thereof.

10. The free-radical carbon-FRTS-carbon crosslinkable polymeric composition of claim 9 wherein the hindered amine-derived free radical trapping species having at least two nitroxyl groups derived from oxo-TEMPO, hydroxy-TEMPO, esters of hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, or metal complexes with TEMPO.

11. (canceled)

12. A free-radical carbon-FRTS-carbon crosslinkable polymeric composition comprising:
(a) a free-radical degradable polymer and
(b) a free-radical inducing species, and
(c) a free radical trapping species graftable via a free-radical-initiated carbon-FRTS-carbon coupling bond to the polymer,
wherein the resulting rheology-modified polymer having a
Maximum Torque>1.30 * Minimum Torque
measured by a moving die rheometer at the polymer's crosslinking temperature, a frequency of 100 cycles per minute, and an arc of 0.5 degrees.

13. A free-radical carbon-FRTS-carbon crosslinkable polymeric composition comprising:
(a) a free-radical carbon-carbon crosslinkable polymer,
(b) a free-radical inducing species, and
(c) a free radical trapping species having at least two trapping sites,
wherein
(A1) the free radical trapping species (i) substantially suppresses carbon-carbon crosslinking of the polymer in the presence of the free-radical inducing species and (ii) at a trapping site, being graftable onto the first polymer after the first polymer forms a free radical, and
(A2) the free-radical carbon-FRTS-carbon crosslinkable polymeric composition yields a free-radical carbon-FRTS-carbon crosslinked polymer.

14. The free-radical carbon-FRTS-carbon crosslinkable polymeric composition of claim 13 wherein the resulting carbon-FRTS-carbon crosslinked polymer having a gel content as measured by xylene extraction (ASTM 2765) of greater than about 10 weight percent.

15. The free-radical carbon-FRTS-carbon crosslinkable polymeric composition of claim 13 wherein the resulting carbon-FRTS-carbon crosslinked polymer having a gel content as measured by xylene extraction (ASTM 2765) of at least about an absolute 10 weight percent greater than the gel content of the base polymer.

16. The free-radical carbon-FRTS-carbon crosslinkable polymeric composition of claim 13 wherein the carbon-carbon crosslinkable polymer is selected from the group consisting of acrylonitrile butadiene styrene rubber, chloroprene rubber, chlorosulfonated polyethylene rubber, ethylene/alpha-olefin copolymers, ethylene/diene copolymer, ethylene homopolymers, ethylene/propylene/diene monomers, ethylene/propylene rubbers, ethylene/styrene interpolymers, ethylene/unsaturated ester copolymers, fluoropolymers, halogenated polyethylenes, hydrogenated nitrile butadiene rubber, natural rubber, nitrile rubber, polybutadiene rubber, silicone rubber, styrene/butadiene rubber, styrene/butadiene/styrene block copolymers, styrene/ethylene/butadiene/styrene copolymers, and blends thereof.

17. (canceled)

18. A free-radical carbon-FRTS-carbon crosslinkable polymeric composition comprising:
(a) a free-radical carbon-carbon crosslinkable polymer and
(b) a free-radical inducing species, and
(c) a free radical trapping species graftable via a free-radical-initiated carbon-FRTS-carbon coupling bond to the polymer,
wherein the resulting rheology-modified polymer having a
Maximum Torque>1.30 * Minimum Torque
measured by a moving die rheometer at the polymer's crosslinking temperature, a frequency of 100 cycles per minute, and an arc of 0.5 degrees.

19-29. (canceled)
